(19) United States
(12) Patent Application Publication
(10) Pub. No.: US 2026/0331094 A1
(43) Pub. Date: Oct. 22, 2026

(54) SPEECH RECOGNITION

(71) Applicants: Bytedance Technology Ltd., Grand Cayman (KY); Beijing Zitiao Network Technology Co., Ltd., Beijing (CN)

(72) Inventors: Xiaohai Tian, Singapore (SG); Xianzhao Chen, Beijing (CN); Lu Huang, Beijing (CN); Jun Zhang, Beijing (CN); Lu Lu, Los Angeles, CA (US)

(21) Appl. No.: 19/651,558

(22) Filed: Apr. 17, 2026

(30) Foreign Application Priority Data
Apr. 17, 2025 (CN) 202510486576.1

(51) Int. Cl. G10L 15/02; G10L 15/06; G10L 15/16; G10L 15/183; G10L 15/24

(52) U.S. Cl. CPC G10L 15/02; G10L 15/063; G10L 15/16; G10L 15/183; G10L 15/24

(57) ABSTRACT

The disclosure provides a method, an apparatus, a device, a storage medium and a program product for speech recognition. The method includes: extracting an audio feature representation of an audio to be recognized; extracting a visual feature representation of visual data associated with the audio, the visual data including an image or a video; and determining, using a trained machine learning model, a speech recognition result of the audio based on the audio feature representation and the visual feature representation.

### CROSS-REFERENCE

The present application claims priority to Chinese Patent Application No. 202510486576.1, filed on Apr. 17, 2025 and entitled “METHOD, APPARATUS, DEVICE, STORAGE MEDIUM AND PROGRAM PRODUCT FOR SPEECH RECOGNITION”, the entirety of which is incorporated herein by reference.

### FIELD

Example embodiments of the present disclosure generally relate to the field of computers, and in particular, to speech recognition.

### BACKGROUND

With the development of Internet technologies, more and more applications or platforms provide natural language processing functions, which brings great convenience to users. An application or platform with a natural language processing function may provide a user with natural language processing services based on a trained machine learning model. A speech recognition (Automatic Speech Recognition, ASR) task is an important task among natural language processing tasks. At present, it is also desired to continue to improve the accuracy and efficiency of speech recognition.

### SUMMARY

In a first aspect of the present disclosure, a speech recognition method is provided. The method includes: extracting an audio feature representation of an audio to be recognized; extracting a visual feature representation of visual data associated with the audio, the visual data including an image or a video; and determining, using a trained machine learning model, a speech recognition result of the audio based on the audio feature representation and the visual feature representation.

In a second aspect of the present disclosure, an apparatus for speech recognition is provided. The apparatus includes: an audio feature extraction module configured to extract an audio feature representation of an audio to be recognized; a visual feature extraction module configured to extract a visual feature representation of visual data associated with the audio, the visual data including an image or a video; and a recognition result determination module configured to determine, using a trained machine learning model, a speech recognition result of the audio based on the audio feature representation and the visual feature representation.

In a third aspect of the present disclosure, an electronic device is provided. The device includes at least one processor; and at least one memory coupled to the at least one processor and storing instructions executable by the at least one processor. The instructions, when executed by the at least one processor, cause the electronic device to perform the method of the first aspect.

In a fourth aspect of the present disclosure, a computer-readable storage medium is provided. The computer-readable storage medium has computer-executable instructions stored thereon, the computer-executable instructions, when executed by a processor, implementing the method of the first aspect.

In a fifth aspect of the present disclosure, a computer program product is provided. The computer program product includes computer-executable instructions, where the computer-executable instructions, when executed by a processor, implement the method according to the first aspect of the present disclosure.

It should be understood that the content described in the content part of the present disclosure is not intended to limit key features or important features of the embodiments of the present disclosure, and is also not intended to limit the scope of the present disclosure. Other features of the present disclosure will become readily understood through the following description.

### BRIEF DESCRIPTION OF THE DRAWINGS

The above and other features, advantages, and aspects of the embodiments of the present disclosure will become more apparent in combination with the drawings and with reference to the following detailed description. In the drawings, the same or similar reference numerals refer to the same or similar elements, where:

FIG. 1 shows a schematic diagram of an example environment in which the embodiments of the present disclosure can be implemented;

FIG. 2 shows an example architecture for speech recognition according to some embodiments of the present disclosure;

FIG. 3 shows a flowchart of a method for speech recognition according to some embodiments of the present disclosure;

FIG. 4 shows an example structural block diagram of an apparatus for speech recognition according to some embodiments of the present disclosure; and

FIG. 5 shows a block diagram of an electronic device that may implement one or more embodiments of the present disclosure.

### DETAILED DESCRIPTION

The embodiments of the present disclosure will be described in more detail below with reference to the drawings. Although some embodiments of the present disclosure are shown in the drawings, it should be understood that the present disclosure may be implemented in various forms, and should not be interpreted as limited to the embodiments set forth herein. Instead, these embodiments are provided for a more thorough and complete understanding of the present disclosure. It should be understood that the drawings and embodiments of the present disclosure are only used for purposes of example, and are not used to limit the protection scope of the present disclosure.

In the description of the embodiments of the present disclosure, the term “comprise” and similar terms should be understood as open-ended inclusions, that is, “comprise but not limited to”. The term “based on” should be understood as “at least partially based on”. The term “one embodiment” or “the embodiment” should be understood as “at least one embodiment”. The term “some embodiments” should be understood as “at least some embodiments”. The following may also include other explicit and implicit definitions.

Herein, unless explicitly stated, “performing a step in response to A” does not mean that the step is performed immediately after “A”, rather, one or more intermediate steps may be included.

It may be understood that the data involved in the technical solution (including but not limited to the data itself, acquisition, use, storage or deletion of the data) should comply with requirements of corresponding laws, regulations and related provisions.

It may be understood that before using the technical solutions disclosed in the embodiments of the present disclosure, the user shall be informed of the type, range of use, use scenarios, etc., of personal information involved in the present disclosure and the authorization of the user shall be obtained through appropriate means in accordance with relevant laws and regulations.

For example, in response to receiving an active request from the user, prompt information is sent to the user to clearly prompt the user that the requested operation will require access to and use of the user's personal information, so that the user may independently choose whether to provide the personal information to software or hardware, such as an electronic device, an application, a server or a storage medium, that perform the operations of the technical solutions of the present disclosure based on the prompt information.

As an optional but non-limiting implementation, in response to receiving the active request from the user, the prompt information may be sent to the user in the form of, for example, a pop-up window, in which the prompt information may be presented in text. In addition, the pop-up window may also include a selection control for the user to select “agree” or “disagree” to provide the personal information to the electronic device.

It may be understood that the above process of notifying and obtaining user authorization is only illustrative, and does not limit the implementations of the present disclosure. Other methods that meet relevant laws and regulations may also be applied to the implementations of the present disclosure.

As used herein, the term “model” may learn the correlation between corresponding input and output from training data, so that the corresponding output may be generated for a given input after the training is completed. The generation of the model may be based on machine learning techniques. Deep learning is a machine learning algorithm that uses multiple layers of processing units to process input and provide corresponding output. A neural network model is an example of a model based on deep learning. Herein, the “model” may also be referred to as a “machine learning model”, a “learning model”, a “machine learning network” or a “learning network”, and these terms are used interchangeably herein.

A “neural network” is a machine learning network based on deep learning. A neural network may process input and provide corresponding output, and usually includes an input layer and an output layer, and one or more hidden layers between the input layer and the output layer. The neural network used in deep learning applications usually includes many hidden layers to increase the depth of the network. The layers of the neural network are connected in sequence, so that the output of the previous layer is provided as the input of the next layer, where the input layer receives the input of the neural network, and the output of the output layer is used as the final output of the neural network. Each layer of the neural network includes one or more nodes (also referred to as processing nodes or neurons), and each node processes input from the previous layer.

Generally, machine learning may roughly include three stages, namely, a training stage, a testing stage, and an application stage (also referred to as an inference stage). In the training stage, a given model may be trained using a large amount of training data, and a parameter value may be continuously updated through iteration until the model can obtain consistent inference from the training data to meet an expected target. Through training, the model may be considered to be able to learn the correlation from input to output (also referred to as mapping from input to output) from the training data. The parameter value of the trained model is determined. In the testing stage, test input is applied to the trained model to test whether the model can provide correct output, thereby determining the performance of the model. The testing stage may sometimes be fused into the training stage. In the application or inference stage, the trained model may be used to process actual model input based on the parameter value obtained through training, to determine the corresponding model output.

Traditionally, an application or platform with a speech recognition function may directly use a machine learning model for performing a speech recognition task (that is, a speech recognition model) to perform speech recognition on an audio to be recognized. However, in scenarios such as heavy environmental noise, multiple speakers, or conversations involving a specific field, the accuracy of a speech recognition result obtained by performing speech recognition on an audio only by relying on the speech recognition model may be poor. In particular, in a conference scenario in a specific professional field, performing speech recognition based only on audio may not accurately recognize some professional terms. For example, in a medical lecture scenario, a recognition result of audio “diabetes” may be “diet beats”. For another example, in a scenario of animal medical treatment, a recognition result of audio “it” may be “he” or “it”.

In addition, with the further development of computer vision and natural language processing technologies, the application of multimodal speech recognition combined with visual data has become more extensive. Multimodal speech recognition may bring better experience to fields such as human-computer interaction, intelligent assistants, and automatic subtitle generation. Therefore, it is expected to provide accurate and efficient speech recognition services in conjunction with visual data.

In view of this, according to the embodiments of the present disclosure, an improved solution for speech recognition is provided. According to the solution of the embodiments of the present disclosure, an audio to be recognized and visual data associated with the audio are obtained, where the visual data includes an image or video. An audio feature representation of the audio and a visual feature representation of the visual data are extracted from the audio and the visual data, respectively. A trained machine learning model is used to determine a speech recognition result of the audio based on the audio feature representation and the visual feature representation.

In this way, the machine learning model may be enabled to directly determine the speech recognition result of the audio based on the audio feature representation of the audio and the visual feature representation of the visual data, which helps to improve the accuracy and efficiency of speech recognition performed on the audio.

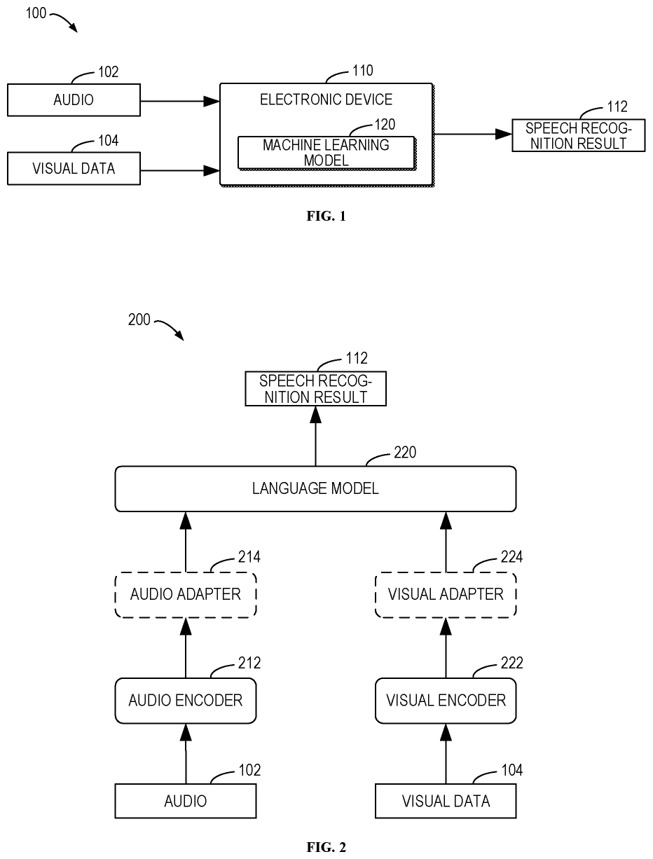

FIG. 1 shows a schematic diagram of an example environment 100 in which the embodiments of the present disclosure can be implemented. In this example environment 100, an electronic device 110 may obtain an audio 102 to be recognized and visual data 104 associated with the audio 102. The audio 102 may be audio of any appropriate duration, any appropriate timbre, and any appropriate language. The visual data 104 may include an image in any appropriate format and any appropriate size. The visual data 104 may also include a video of any appropriate duration and any appropriate format. Both the audio 102 and the visual data 104 may be data collected by the electronic device 110 in real time or data pre-stored locally.

The electronic device 110 may determine a speech recognition result 112 of the audio 102 based on the audio 102 and the visual data 104 by using a trained machine learning model 120. The speech recognition result 112 may be text obtained by performing speech recognition on the audio 102. The machine learning model 120 may be based on any appropriate model structure, including but not limited to a transformer model, a convolutional neural network (CNN), a recurrent neural network (RNN), a deep neural network (DNN), etc.

In some embodiments, the machine learning model 120 may be based on a language model (LM). By learning from a large amount of corpus, the language model may have the question answering capability, and may determine, based on the received input, a specific requirement in the input, and generate a corresponding reply to satisfy the determined requirement. The machine learning model 120 may also be based on other appropriate models.

The machine learning model 120 may include one or more machine learning models. It should be noted that if the machine learning model 120 includes a plurality of machine learning models, the plurality of machine learning models may have different structures, purposes, and functions, which is not limited in the present disclosure.

The electronic device 110 may be any type of device having a computing capability, including a terminal device or a server device. The terminal device may be any type of mobile terminal, fixed terminal, or portable terminal, including a mobile phone, a desktop computer, a laptop computer, a notebook computer, a netbook computer, a tablet computer, a media computer, a multimedia tablet, a personal communication system (PCS) device, a personal navigation device, a personal digital assistant (PDA), an audio/video player, a digital camera/video camera, a positioning device, a television receiver, a radio broadcast receiver, an e-book device, a game device, or any combination thereof, including fittings and peripherals of these devices or any combination thereof.

The server device may be an independent physical server, a server cluster or a distributed system composed of multiple physical servers, or a cloud server that provides basic cloud computing services such as cloud services, cloud databases, cloud computing, cloud functions, cloud storage, network services, cloud communications, middleware services, domain name services, security services, content delivery networks, and big data and artificial intelligence platforms. The server device may include, for example, a computing system/server, such as a mainframe, an edge computing node, a computing device in a cloud environment, etc.

It should be understood that the structures and functions of the elements in the environment 100 are described for purposes of example only, without suggesting any limitation to the scope of the present disclosure.

The speech recognition method according to the present disclosure may be implemented at the electronic device 110. The electronic device 110 obtains an audio to be recognized and visual data associated with the audio. The visual data includes an image or a video. As an example, if the audio is audio collected in an online conference scenario, a screen sharing scenario, etc., the visual data associated with the audio may be a screen-recorded video of content presented on a screen, or a shared screen image. If the audio is audio collected for an actual scenario, the visual data may be a video or an image collected for the current scenario.

The electronic device 110 may extract an audio feature representation of the audio and a visual feature representation of the visual data from the audio and the visual data, respectively. The electronic device 110 may extract the feature representations in any appropriate manner. The electronic device 110 may further determine a speech recognition result of the audio based on the audio feature representation and the visual feature representation by using a trained machine learning model (for example, the machine learning model 120). The machine learning model 120 may determine content of the visual data, for example, based on the visual feature representation. The content of the visual data may indicate, for example, a background corresponding to the audio, an environment corresponding to the audio, or an object involved in the audio.

For example, if the visual data is a conference video in a specific professional field, the machine learning model 120 may determine, based on the visual feature representation of the visual feature, that the audio is audio in the specific professional field, and then perform speech recognition in conjunction with knowledge in the specific professional field, which may help the machine learning model 120 recognize the audio more accurately. For another example, if it is determined that the scene corresponding to the audio is a smart home scene, the audio includes content such as “turn it on”, and the visual data includes a smart home appliance, the machine learning model 120 may determine that “turn it on” in the audio means turning on the smart home appliance, which may help the machine learning model 120 better understand the semantics of the audio. Therefore, by combining the visual data, it may help the machine learning model 120 better understand the content and semantics of the audio, which facilitates the improvement of the accuracy of speech recognition.

Compared with the manner of providing text associated with the visual data (for example, text recognized from the visual data and summary text generated based on the understanding of the visual data) to the machine learning model for speech recognition, the manner of directly providing the visual feature representation may, on one hand, avoid the speech recognition error caused by the text error, which helps to improve the accuracy of speech recognition. On the other hand, it is not necessary to perform recognition on the visual data in advance to determine the text associated with the visual data, which helps to improve the overall efficiency of speech recognition.

In some embodiments, the machine learning model 120 may be constructed based on a language model. To enable the language model to better process the audio feature representation and the visual feature representation, the electronic device 110 may obtain a prompt template for the language model. The electronic device 110 may determine a model input for the machine learning model by filling the audio feature representation and the visual feature representation into the prompt template. The electronic device 110 may further provide the model input to the machine learning model 120, and determine, using the machine learning model 120, the speech recognition result corresponding to the audio. In the embodiments of the present disclosure, a single language model is used to complete the speech recognition task in conjunction with visual information based on the feature representation, which may achieve faster processing speed and higher real-time performance. In addition, due to the simple model architecture, the amount of computation and memory space may also be reduced.

Regarding the specific manner of extracting the audio feature representation and the visual feature representation, in the embodiments of the present disclosure, the electronic device 110 may extract the feature representations in any appropriate manner, which is not limited in the present disclosure. In some embodiments, the electronic device 110 may use a trained encoder to extract the feature representations. As an example, the electronic device 110 may use an audio encoder to extract the audio feature representation of the audio, and use a trained visual encoder to extract the visual feature representation of the visual data. In some embodiments, the audio encoder and the visual encoder may be different machine learning models from the machine learning model 120 used to perform speech recognition. In this case, the electronic device 110 may provide the audio and the visual data to the audio encoder and the visual encoder, respectively, and obtain the output of the audio encoder (that is, the audio feature representation of the audio) and the output of the visual encoder (that is, the visual feature representation of the visual data). The electronic device 110 may determine a model input for the machine learning model 120 based on the obtained audio feature representation and the obtained visual feature representation, and provide the model input to the machine learning model 120 to determine the speech recognition result of the audio using the machine learning model 120.

In some embodiments, the audio encoder and the visual encoder may also be part of the machine learning model 120 for performing speech recognition. In this case, the electronic device 110 may directly provide the audio and the visual data to the machine learning model 120, and directly obtain the speech recognition result of the audio output by the machine learning model 120.

Referring to FIG. 2, FIG. 2 shows an example architecture 200 for speech recognition according to some embodiments of the present disclosure. The example architecture 200 may be implemented at the electronic device 110. The example architecture 200 at least involves an audio encoder 212, a visual encoder 222, and a language model 220. The electronic device 110 may extract an audio feature representation of the audio 102 using the audio encoder 212 and extract a visual feature representation of the visual data 104 using the visual encoder 222 in response to acquiring the audio 102 to be recognized and the visual data 104 matching the audio 102. For example, the electronic device 110 may directly provide the audio feature representation and the visual feature representation to the language model 220.

In some embodiments, to improve the accuracy of speech recognition performed by the language model 220, the electronic device 110 may further use an appropriate adapter to process the audio feature representation and the visual feature representation. The adapter is configured to map the input feature representation to a feature space matching the machine learning model (that is, the language model 220), so that the machine learning model may understand and process the feature representation. As an example, the example architecture 200 may further include an audio adapter 214 and a visual adapter 224.

The electronic device 110 may perform processing on the audio feature representation using the trained audio adapter 214 to determine an audio feature representation matching the language model 220, and perform processing on the visual feature representation using the trained visual adapter 224 to determine a visual feature representation matching the language model 220. It should be noted that the audio adapter 214 and the visual adapter 224 are adapters for the language model 220, and both of them need to be trained together with the language model 220.

Both the processed audio feature representation and the processed visual feature representation may be mapped to the feature space matching the language model 220. In this case, the input features of the language model 220 include the processed audio feature representation and the processed visual feature representation. The electronic device 110 may determine the speech recognition result 112 of the audio 102 based on the model input using the language model 220.

Therefore, the language model 220 may determine a scene corresponding to the audio based on the received visual feature representation, and perform speech recognition on the audio based on the corresponding scene to determine the speech recognition result of the audio. For example, if the visual feature representation indicates that the audio corresponds to a scene in a specific professional field, the language model 220 may perform speech recognition based on relevant knowledge in the specific professional field, which facilitates the accurate recognition of professional terms in the field, thereby improving the accuracy of speech recognition.

The application of the machine learning model 120 is described above, and the training manner of the machine learning model 120 is described below. It should be noted that the machine learning model 120 may be trained at any appropriate electronic device. In this paper, the machine learning model 120 is trained at the electronic device 110 as an example for description.

Continuing to refer to FIG. 2, if no adapter is involved (that is, the example architecture 200 does not include the audio adapter 214 and the visual adapter 224), the audio feature representation extracted by the audio encoder 212 and the visual feature representation extracted by the visual encoder 222 will be directly provided to the language model 220, and the electronic device 110 may jointly train the audio encoder 212, the visual encoder 222, and the language model 220.

If an adapter is involved (that is, the example architecture 200 includes the audio adapter 214 and the visual adapter 224), the electronic device 110 may directly obtain the trained audio encoder 212 and the trained visual encoder 222, and the electronic device 110 may train only the audio adapter 214, the visual adapter 224, and the language model 220. Since the number of parameters of the adapter is less than that of the encoder, this manner may reduce the difficulty of model training and improve the training efficiency.

Certainly, the electronic device 110 may also train the audio encoder 212, the audio adapter 214, the visual encoder 222, the visual adapter 224, and the language model 220 together. The audio encoder 212 and/or the audio adapter 214 and the language model 220 may be referred to as an audio branch for reply, and the visual encoder 222 and/or the visual adapter 224 and the language model 220 may be referred to as a visual branch for reply.

In some embodiments, the training process of the language model 220 includes at least a first training stage and a second training stage. The electronic device 110 may use first training data to train the audio encoder 212 and/or the audio adapter 214 and the language model 220 in the first training stage. The first training data may include a plurality of sample audio-text pairs, and each sample audio-text pair may include a sample audio and a speech recognition result of the sample audio.

For example, the electronic device 110 may train the audio encoder 212 and/or the audio adapter 214 and the language model 220 based on the difference between the predicted speech recognition result output by the language model 220 and the speech recognition result in the first training data. That is, the electronic device 110 may train only the audio branch in the first training stage, and the language model 220 that has been through the first training stage may output the speech recognition result of the corresponding audio based on the received audio feature representation.

The electronic device 110 may use the second training data to at least train the visual encoder 222 and/or the visual adapter 224 and the language model 220 in the second training stage. Specifically, if the training process of the language model 220 further includes a third training stage after the second training stage, the second training data may include a plurality of sample visual data-text pairs. Each sample visual data-text pair may include one piece of sample visual data and a sample text corresponding to the sample visual data. For example, each sample text may include a text in the corresponding sample visual data and a description text of the corresponding sample visual data.

The description text of the sample visual data may indicate, for example, the position, size, and distribution of at least one object included in the sample visual data in the sample visual data, the background and foreground of the sample visual data, and the color and size of the sample visual data. For example, if a piece of sample visual data is an image, the sample text corresponding to the sample visual data may include a text in the image (for example, a subtitle, a word on an item, etc.) and a description text of the image. In this case, the electronic device 110 may train only the visual branch in the second training stage, and the machine learning model that has been through the second training stage may output the text of the corresponding visual data based on the received visual feature representation.

The electronic device 110 may further use the third training data to jointly train the audio branch and the visual branch in the third training stage. For example, the third training data may include at least a plurality of sample visual data-text pairs and a plurality of sample audio-sample visual data-text pairs. Each sample audio-sample visual data-text pair may include a sample audio, sample visual data associated with the sample audio, and a speech recognition result of the sample audio. In some embodiments, the third training data may further include a plurality of sample audio-text pairs. In this case, the electronic device 110 may jointly train the audio branch and the visual branch in the third training stage, and the language model 220 that has been through the third training stage may have the multimodal speech recognition capability, and may determine the recognition result of the audio corresponding to the audio feature representation based on the visual feature representation and the audio feature representation.

If the training process of the language model 220 includes only the first training stage and the second training stage, in some embodiments, the second training data may include only a plurality of sample audio-sample visual data-text pairs, that is, the electronic device 110 may directly jointly train the audio branch and the visual branch in the second training stage. In some embodiments, the second training data may also include a plurality of sample visual data-text pairs and a plurality of sample audio-sample visual data-text pairs, that is, the electronic device 110 may train the visual branch and the overall architecture (that is, the visual branch and the audio branch) at the same time in the second training stage.

In this way, the audio branch and the visual branch for reply may be trained through at least two training stages. The trained audio encoder 212 may extract an accurate audio feature representation from the audio, and the trained visual encoder 222 may extract an accurate visual feature representation from the visual data. The trained audio adapter 214 and the trained visual adapter 224 may accurately map the received feature representations to the feature space matching the language model 220, and the trained language model 220 may determine the speech recognition result corresponding to the audio based on the received audio feature representation and the visual feature representation.

In addition, compared with the case where the text associated with the image is determined first by using the image recognition model (that is, the architecture for determining the reply includes a cascaded image recognition model and language model), the end-to-end architecture of the present disclosure is used to simultaneously optimize the audio and visual features in the training stage without relying on two independent models. This may reduce the possibility of error propagation, help to improve the efficiency and quality of training, and further improve the consistency and real-time performance of the reply architecture in the application stage.

In summary, according to the embodiments of the present disclosure, the machine learning model may directly determine the speech recognition result of the audio based on the audio feature representation of the audio and the visual feature representation of the visual data, which helps to improve the accuracy and efficiency of speech recognition performed on the audio.

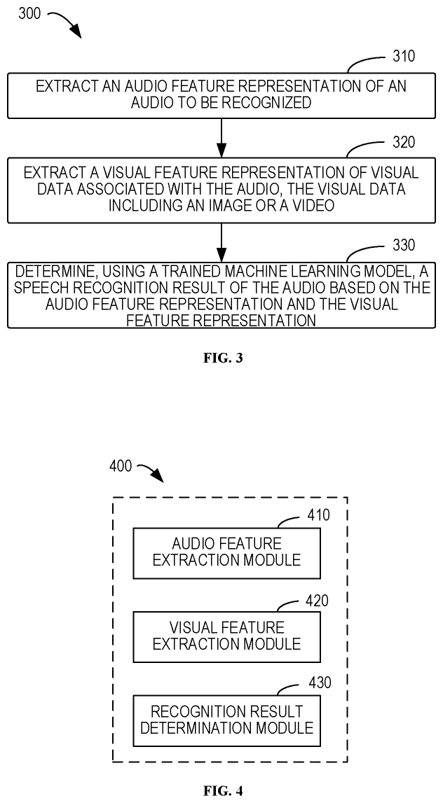

FIG. 3 shows a flowchart of a method 300 for speech recognition according to some embodiments of the present disclosure. The method 300 may be implemented at the electronic device 110 in FIG. 1. The method 300 will be described with reference to the environment 100 in FIG. 1.

At block 310, the electronic device 110 extracts an audio feature representation of an audio to be recognized.

At block 320, the electronic device 110 extracts a visual feature representation of visual data associated with the audio, the visual data including an image or a video.

At block 330, the electronic device 110 determines, using a trained machine learning model, a speech recognition result of the audio based on the audio feature representation and the visual feature representation.

In some embodiments, determining the speech recognition result of the audio includes: performing processing on the audio feature representation using a trained audio adapter to determine an audio feature representation matching the machine learning model; performing processing on the visual feature representation using a trained visual adapter to determine a visual feature representation matching the machine learning model; and determining, using the machine learning model, the speech recognition result of the audio based on the processed audio feature representation and the processed visual feature representation.

In some embodiments, the audio adapter and the visual adapter are jointly trained with the machine learning model, and the audio adapter and the visual adapter are configured to map respective input feature representations to a feature space matching the machine learning model.

In some embodiments, the machine learning model is constructed based on a language model, and determining the speech recognition result of the audio includes: determining a model input for the machine learning model by filling the audio feature representation and the visual feature representation into a prompt template matching the machine learning model; and providing the model input to the machine learning model to determine the speech recognition result using the machine learning model.

In some embodiments, the audio feature representation is extracted using a trained audio encoder, and the visual feature representation is extracted using a trained visual encoder.

In some embodiments, a training process of the machine learning model includes at least a first training stage and a second training stage, the audio encoder and the machine learning model are jointly trained in the first training stage, and the visual encoder and the machine learning model are jointly trained in the second training stage.

In some embodiments, first training data for the first training stage includes a first sample audio and a speech recognition result of the first sample audio, and second training data for the second training stage includes at least: first sample visual data and a first sample text corresponding to the first sample visual data, and/or a second sample audio, second sample visual data associated with the second sample audio, and a speech recognition result of the second sample audio.

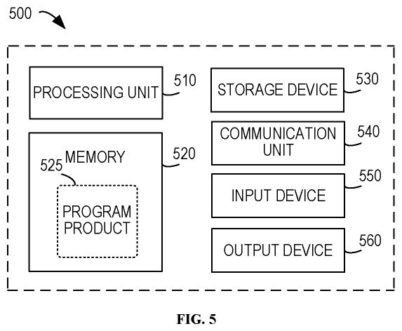

The embodiments of the present disclosure further provide a corresponding apparatus for implementing the above methods or processes. FIG. 4 shows an example structural block diagram of an apparatus 400 for speech recognition according to some embodiments of the present disclosure. The apparatus 400 may be implemented as or included in the electronic device 110. Each module/component in the apparatus 400 may be implemented by hardware, software, firmware, or any combination thereof.

As shown in FIG. 4, the apparatus 400 includes an audio feature extraction module 410 configured to extract an audio feature representation of an audio to be recognized. The apparatus 400 further includes a visual feature extraction module 420 configured to extract a visual feature representation of visual data associated with the audio, the visual data including an image or a video. The apparatus 400 further includes a recognition result determination module 430 configured to determine, using a trained machine learning model, a speech recognition result of the audio based on the audio feature representation and the visual feature representation.

In some embodiments, the recognition result determination module 430 is further configured to: perform processing on the audio feature representation using a trained audio adapter to determine an audio feature representation matching the machine learning model; perform processing on the visual feature representation using a trained visual adapter to determine a visual feature representation matching the machine learning model; and determine, using the machine learning model, the speech recognition result of the audio based on the processed audio feature representation and the processed visual feature representation.

In some embodiments, the audio adapter and the visual adapter are jointly trained with the machine learning model, and the audio adapter and the visual adapter are configured to map respective input feature representations to a feature space matching the machine learning model.

In some embodiments, the machine learning model is constructed based on a language model, and the recognition result determination module 430 is further configured to: determine a model input for the machine learning model by filling the audio feature representation and the visual feature representation into a prompt template matching the machine learning model; and provide the model input to the machine learning model to determine the speech recognition result using the machine learning model.

In some embodiments, the audio feature representation is extracted using a trained audio encoder, and the visual feature representation is extracted using a trained visual encoder.

In some embodiments, a training process of the machine learning model includes at least a first training stage and a second training stage, the audio encoder and the machine learning model are jointly trained in the first training stage, and the visual encoder and the machine learning model are jointly trained in the second training stage.

In some embodiments, first training data for the first training stage includes a first sample audio and a speech recognition result of the first sample audio, and second training data for the second training stage includes at least: first sample visual data and a first sample text corresponding to the first sample visual data, and/or a second sample audio, second sample visual data associated with the second sample audio, and a speech recognition result of the second sample audio.

The units and/or modules included in the apparatus 400 may be implemented in various manners, including software, hardware, firmware, or any combination thereof. In some embodiments, one or more units and/or modules may be implemented using software and/or firmware, for example, machine-executable instructions stored on a storage medium. In addition to machine-executable instructions or as an alternative, some or all units and/or modules in the apparatus 400 may be implemented at least partially by one or more hardware logic components. As an example, rather than a limitation, example types of hardware logic components that may be used include field programmable gate array (FPGA), application specific integrated circuit (ASIC), Application Specific Standard (ASSP), system on chip (SOC), complex programmable logic device (CPLD), and more.

It should be understood that one or more steps of the above methods may be performed by a suitable electronic device or a combination of electronic devices. Such an electronic device or a combination of electronic devices may include, for example, the electronic device 110 in FIG. 1.

FIG. 5 shows a block diagram of an electronic device 500 in which one or more embodiments of the present disclosure may be implemented. It should be understood that the electronic device 500 shown in FIG. 5 is merely for purposes of example, and should not constitute any limitation on the functions and scope of the embodiments described herein. The electronic device 500 shown in FIG. 5 may be used to implement the electronic device 110 in FIG. 1 or the apparatus 400 in FIG. 4.

As shown in FIG. 5, the electronic device 500 is in the form of a general-purpose electronic device. The components of the electronic device 500 may include, but are not limited to, one or more processors or processing units 510, a memory 520, a storage device 530, one or more communication units 540, one or more input devices 550, and one or more output devices 560. The processing unit 510 may be an actual or virtual processor, and may perform various processing based on the program stored in the memory 520. In a multi-processor system, a plurality of processing units execute computer-executable instructions in parallel to improve the parallel processing capability of the electronic device 500.

The electronic device 500 typically includes multiple computer storage medium. Such medium may be any available medium accessible by the electronic device 500, including, but not limited to, volatile and non-volatile medium, removable and non-removable medium. The memory 520 may be volatile memory (for example, a register, cache, a random access memory (RAM)), a non-volatile memory (such as a read-only memory (ROM), an electrically erasable programmable read-only memory (EEPROM), a flash memory), or any combination thereof. The storage device 530 may be any removable or non-removable medium, and may include a machine-readable medium such as a flash drive, a disk, or any other medium, which may be used to store information and/or data and may be accessed within the electronic device 500.

The electronic device 500 may further include additional removable/non-removable, volatile/non-volatile memory medium. Although not shown in FIG. 5, a disk drive for reading from or writing to a removable, non-volatile disk (such as a “floppy disk”), and an optical disk drive for reading from or writing to a removable, non-volatile optical disk may be provided. In these cases, each drive may be connected to the bus (not shown) by one or more data medium interfaces. The memory 520 may include a computer program product 525 having one or more program modules configured to perform various methods or acts of the various embodiments of the present disclosure.

The communication unit 540 implements communication with other electronic devices through the communication medium. Additionally, the functions of the components of the electronic device 500 may be implemented by a single computing cluster or multiple computing machines, and the computing machines may communicate through a communication connection. Therefore, the electronic device 500 may use a logical connection with one or more other servers, a network personal computer (PC), or another network node to operate in a networked environment.

The input device 550 may be one or more input devices, such as a mouse, a keyboard, a tracking ball, etc. The output device 560 may be one or more output devices, such as a display, a speaker, a printer, etc. The electronic device 500 may further communicate with one or more external devices (not shown) through the communication unit 540 as needed, and the external devices such as a storage device, a display device, etc., communicate with one or more devices that enable the user to interact with the electronic device 500, or communicate with any devices (for example, a network card, a modem, etc.) that enable the electronic device 500 to communicate with one or more other electronic devices. Such communication may be performed via input/output (I/O) interfaces (not shown).

According to an example implementation of the present disclosure, there is provided a computer-readable storage medium having computer-executable instructions stored thereon, where the computer-executable instructions are executed by a processor to implement the method described above. According to an example implementation of the present disclosure, there is further provided a computer program product tangibly stored on a non-transitory computer-readable medium and including computer-executable instructions, the computer-executable instructions being executed by a processor to implement the method described above.

Various aspects of the present disclosure are described herein with reference to flowcharts and/or block diagrams of methods, apparatuses, devices, and computer program products implemented according to the present disclosure. It should be understood that each block of the flowchart and/or block diagrams, and combinations of blocks in the flowchart and/or block diagrams, may be implemented by computer-readable program instructions.

These computer-readable program instructions may be provided to a processing unit of a general-purpose computer, a special-purpose computer, or other programmable data processing apparatus to produce a machine, such that when the instructions are executed by the processing unit of the computer or other programmable data processing apparatus, an apparatus for implementing the functions/acts specified in one or more blocks of the flowchart and/or block diagrams is produced. These computer-readable program instructions may also be stored in a computer-readable storage medium, these instructions cause a computer, a programmable data processing apparatus, and/or other devices to work in a specific manner, and thus, the computer-readable medium storing the instructions includes a manufactured product, which includes instructions for implementing various aspects of the functions/acts specified in one or more blocks of the flowchart and/or block diagrams.

The computer-readable program instructions may be loaded onto a computer, other programmable data processing apparatus, or other devices, so that a series of operation steps are performed on the computer, other programmable data processing apparatus, or other devices to produce a computer-implemented process, such that the instructions executed on the computer, other programmable data processing apparatus, or other devices implement the functions/acts specified in one or more blocks of the flowchart and/or block diagrams.

The flowchart and block diagrams in the drawings show the possibly implemented architectures, functions, and operations of the system, method, and computer program product according to multiple implementations of the present disclosure. In this regard, each block in the flowchart or block diagrams may represent a module, program segment, or part of instructions, and the module, program segment, or part of instructions contains one or more executable instructions for implementing the specified logical functions. In some updated implementations, the functions marked in the blocks may also occur in an order different from that marked in the drawings. For example, two consecutive blocks may actually be performed substantially in parallel, or they may sometimes be performed in the reverse order, depending on the functions involved. It should also be noted that each block in the block diagrams and/or flowcharts, and combinations of the blocks in the block diagrams and/or flowcharts may be implemented by a special-purpose hardware-based system that executes specified functions or acts, or may be implemented by a combination of special-purpose hardware and computer instructions.

The implementations of the present disclosure have been described above, and the above description is for purposes of example, non-exhaustive, and not limited to the disclosed implementations. Without departing from the scope and spirit of the illustrated implementations, many modifications and changes will be apparent to those of ordinary skill in the art. The selection of terms used herein is intended to best explain the principles, practical applications, or improvements to the technology in the market of the implementations, or to enable other ordinary skilled persons in the art to understand the implementations disclosed herein.

1. A speech recognition method, comprising:
extracting an audio feature representation of an audio;
extracting a visual feature representation of visual data associated with the audio, the visual data comprising an image or a video; and
determining, using a machine learning model, a speech recognition result of the audio based on the audio feature representation and the visual feature representation.

2. The method of claim 1, wherein determining the speech recognition result of the audio comprises:
performing processing on the audio feature representation using an audio adapter to determine an audio feature representation matching the machine learning model;
performing processing on the visual feature representation using a visual adapter to determine a visual feature representation matching the machine learning model; and
determining, using the machine learning model, the speech recognition result of the audio based on the audio feature representation matching the machine learning model and the visual feature representation matching the machine learning model.

3. The method of claim 2, wherein the audio adapter and the visual adapter are jointly trained with the machine learning model, and wherein the audio adapter and the visual adapter are configured to map respective input feature representations to a feature space matching the machine learning model.

4. The method of claim 1, wherein the machine learning model is constructed based on a language model, and wherein determining the speech recognition result of the audio comprises:
determining a model input for the machine learning model by filling the audio feature representation and the visual feature representation into a prompt template matching the machine learning model; and
providing the model input to the machine learning model to determine the speech recognition result using the machine learning model.

5. The method of claim 1, wherein the audio feature representation is extracted using an audio encoder, and wherein the visual feature representation is extracted using a visual encoder.

6. The method of claim 5, wherein a training process of the machine learning model comprises at least a first training stage and a second training stage, and wherein the audio encoder and the machine learning model are jointly trained in the first training stage, and the visual encoder and the machine learning model are jointly trained in the second training stage.

7. The method of claim 6, wherein first training data for the first training stage comprises a first sample audio and a speech recognition result of the first sample audio, and
wherein second training data for the second training stage comprises at least:
first sample visual data and a first sample text corresponding to the first sample visual data, and/or a second sample audio, second sample visual data associated with the second sample audio, and a speech recognition result of the second sample audio.

8. An electronic device, comprising:
at least one processor; and
at least one memory, the at least one memory being coupled to the at least one processor and storing instructions for execution by the at least one processor, the instructions, when executed by the at least one processor, causing the electronic device to perform acts comprising:
extracting an audio feature representation of an audio;
extracting a visual feature representation of visual data associated with the audio, the visual data comprising an image or a video; and
determining, using a machine learning model, a speech recognition result of the audio based on the audio feature representation and the visual feature representation.

9. The electronic device of claim 8, wherein determining the speech recognition result of the audio comprises:
performing processing on the audio feature representation using an audio adapter to determine an audio feature representation matching the machine learning model;
performing processing on the visual feature representation using a visual adapter to determine a visual feature representation matching the machine learning model; and
determining, using the machine learning model, the speech recognition result of the audio based on the audio feature representation matching the machine learning model and the visual feature representation matching the machine learning model.

10. The electronic device of claim 9, wherein the audio adapter and the visual adapter are jointly trained with the machine learning model, and wherein the audio adapter and the visual adapter are configured to map respective input feature representations to a feature space matching the machine learning model.

11. The electronic device of claim 8, wherein the machine learning model is constructed based on a language model, and wherein determining the speech recognition result of the audio comprises:
determining a model input for the machine learning model by filling the audio feature representation and the visual feature representation into a prompt template matching the machine learning model; and
providing the model input to the machine learning model to determine the speech recognition result using the machine learning model.

12. The electronic device of claim 8, wherein the audio feature representation is extracted using an audio encoder, and wherein the visual feature representation is extracted using a visual encoder.

13. The electronic device of claim 12, wherein a training process of the machine learning model comprises at least a first training stage and a second training stage, and wherein the audio encoder and the machine learning model are jointly trained in the first training stage, and the visual encoder and the machine learning model are jointly trained in the second training stage.

14. The electronic device of claim 13, wherein first training data for the first training stage comprises a first sample audio and a speech recognition result of the first sample audio, and
wherein second training data for the second training stage comprises at least:
first sample visual data and a first sample text corresponding to the first sample visual data, and/or a second sample audio, second sample visual data associated with the second sample audio, and a speech recognition result of the second sample audio.

15. A non-transitory computer-readable storage medium having computer-executable instructions stored thereon, the computer-executable instructions being executable by a processor to implement a method, comprising
extracting an audio feature representation of an audio;
extracting a visual feature representation of visual data associated with the audio, the visual data comprising an image or a video; and
determining, using a machine learning model, a speech recognition result of the audio based on the audio feature representation and the visual feature representation.

16. The non-transitory computer-readable storage medium of claim 15, wherein determining the speech recognition result of the audio comprises:
performing processing on the audio feature representation using an audio adapter to determine an audio feature representation matching the machine learning model;
performing processing on the visual feature representation using a visual adapter to determine a visual feature representation matching the machine learning model; and
determining, using the machine learning model, the speech recognition result of the audio based on the audio feature representation matching the machine learning model and the visual feature representation matching the machine learning model.

17. The non-transitory computer-readable storage medium of claim 16, wherein the audio adapter and the visual adapter are jointly trained with the machine learning model, and wherein the audio adapter and the visual adapter are configured to map respective input feature representations to a feature space matching the machine learning model.

18. The non-transitory computer-readable storage medium of claim 15, wherein the machine learning model is constructed based on a language model, and wherein determining the speech recognition result of the audio comprises:
determining a model input for the machine learning model by filling the audio feature representation and the visual feature representation into a prompt template matching the machine learning model; and
providing the model input to the machine learning model to determine the speech recognition result using the machine learning model.

19. The non-transitory computer-readable storage medium of claim 15, wherein the audio feature representation is extracted using an audio encoder, and wherein the visual feature representation is extracted using a visual encoder.

20. The non-transitory computer-readable storage medium of claim 19, wherein a training process of the machine learning model comprises at least a first training stage and a second training stage, and wherein the audio encoder and the machine learning model are jointly trained in the first training stage, and the visual encoder and the machine learning model are jointly trained in the second training stage.
